(19) United States
(12) Patent Application Publication
(10) Pub. No.: US 2004/0108353 A1
(43) Pub. Date: Jun. 10, 2004

(54) Combustion-engined setting tool

(76) Inventors: Iwan Wolf, Chur (CH); Joachim Thieleke, Wasserburg (DE); Lothar Werle, Frastanz (AT)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/715,766

(22) Filed: Nov. 18, 2003

(30) Foreign Application Priority Data
Nov. 19, 2002 (DE) 102 53 670.8

(51) Int. Cl. B25C 1/14

(52) U.S. Cl. 227/10

(57) ABSTRACT

A combustion-engined setting tool for driving fastening elements into a constructional component includes a piston guide (12) adjoining the combustion chamber (14), a drive piston displaceable in the piston guide (12) under action of expanding combustion gases produced by combustion of oxidation medium-fuel mixture in the combustion chamber (14), at least on magnetic piston-retaining element (31) for temporarily retaining the drive piston (13) at the combustion chamber (14); and at least one magnetic conducting element (32) for transmitting a magnetic holding force from the magnetic piston-retaining element (31) to the drive piston (13).

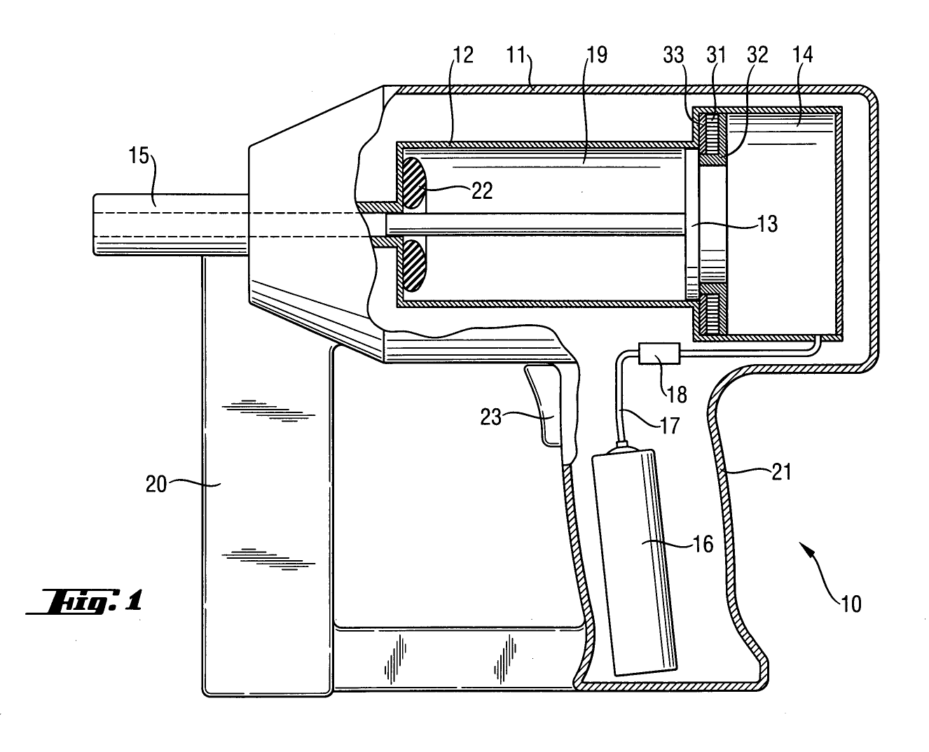

### BACKGROUND OF THE INVENTION

1. Field of the Invention

The present invention. relates to a combustion-engined setting tool for driving fastening elements into a constructional component and including at least one combustion chamber for combusting a fuel-oxidation means mixture, a piston guide adjoining the combustion chamber, a drive piston displaceable in the piston guide under action of expanding combustion gases, magnetic piston-retaining means for temporary retaining the drive piston at the combustion chamber, and at least one magnetic conducting element for transmitting a magnetic holding force from the magnetic piston-retaining means to the drive piston.

2. Description of the Prior Art

Setting tools of the type described above can operate on gaseous or evaporating liquefied or fluid fuel which is combusted in the combustion chamber, with the combustion gases driving the piston that drives the fastening elements into the constructional component.

Generally, it is desirable to achieve, in these setting tools, the highest possible efficiency. In order to achieve the desired efficiency, the most isohoric combustion is required, i. e., the piston should not displace until a maximum pressure is obtained in the combustion chamber. In order to prevent a premature displacement of the piston, piston-retaining means is used. As practical piston-retaining means, a magnetic device that retains the piston in its upper dead point position at the combustion chamber is used.

German Publication DE 40 32 202 A1 discloses a combustion-engined setting tool in which permanent magnet means is arranged on a wall of the combustion chamber adjacent to the piston for temporary retaining the piston which is made at least partially of a magnetic flux-conducting material.

The drawback of the setting tool of DE 40 32 202 A1 consists in that during return of the piston to its upper dead point position, the magnet means is subjected to strong impacts. With the magnet means being made of a brittle material, the impacts can lead to breaking of the magnet means. Further, because of its contact with the piston, the magnet means is located in a very hot region of the setting tool. Because of high temperatures, the magnet means can be demagnetized.

Accordingly, an object to the present invention is to provide a combustion-engined setting tool of the type discussed above in which the above-mentioned drawbacks are eliminated and which would have a very high efficiency.

### SUMMARY OF THE INVENTION

This and other objects of the present invention, which will become apparent hereinafter, are achieved by providing in the setting tool, at least one magnetic flux-conducting element for transmitting a magnetic holding force from the magnetic piston-retaining means to the drive piston.

Because the transmission of the magnetic holding or retaining force from the magnetic piston-retaining means, e.g., a permanent magnet, to the drive piston is effected by a magnetic flux-conducting element, the magnetic piston-retaining means does not contact the. drive piston directly any more. In this way, the magnetic piston-retaining means is protected from impacts by the drive piston. In a particular case, the magnetic piston-retaining means can be arranged outside of the hot combustion zone. In this case, the magnetic piston retaining means is protected from action of heat.

If there are provided several magnetic piston-retaining elements, each retaining element is associated with a separate magnetic-flux conducting element. This insures an optimal transmission of the magnetic flux.

According to a further advantageous embodiment of the present invention, the magnetic piston retaining means is formed as permanent magnet means.

By forming the magnetic piston-retaining means as electromagnet means, the retaining force of the magnetic piston-retaining means can be varied in order to adapt the retaining force to the existing environmental and other operational conditions (outer temperature, tool temperature, etc.

The retaining force can be substantially increased by forming the magnetic flux-conducting element as a pole piece.

By providing a spacer or spacers, which are formed advantageously as shock-absorbing or thermo-insulating elements, between the magnetic piston-retaining means or retaining elements and the drive piston, both the thermal load and the shock load acting on the magnetic piston-retaining means (elements) can be substantially reduced.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS:

Single figure of the drawings shows a partially cross-sectional view of a combustion-engined setting tool according to the present invention.

### DETAILED DESCRIPTION OF THE PREFERRED EMBODIMENTS

A combustion-engined setting tool 10 according to the present invention, which is shown in the drawing, is shown in its idle or inoperative, initial position. The setting tool 10 has a one- or multi-part housing 11 in which a setting mechanism is arranged. With the setting mechanism, fastening elements, such as nails, bolts and the like can be driven in a constructional component (not shown) when the setting tool 10 is pressed, with its bolt guide 15, against the constructional component.

The setting mechanism includes, among others, a combustion chamber 14 and a piston guide 12 in which a drive piston 13 is axially displaceable. The bolt guide 15, in which a fastening element is located, also forms part of the setting mechanism. During a setting process, the fastening element is driven into the constructional component with a setting direction end of the drive piston or its piston rod.

The bolt guide 15 adjoins the piston guide 12. In the front region of the piston guide 12, there are provided damping elements 22 which damp, during a setting process, the impact of the forward accelerating piston 13. The fastening elements can be stored, e.g., in al magazine 20 securable on the setting tool 10. The setting tool 10 can be driven with a fuel gas or with an evaporated liquefied fuel stored in a fuel tank 16 or a fuel container. A fuel conduit 17 extends from the fuel tank 16 and leads to the combustion chamber 14. In the fuel conduit 17, there is provided a metering device 18 that delivers into the combustion chamber 14 a fuel amount necessary for effecting a setting process. The metering device 18 can also be so formed that it adds or admixes to the fuel an oxidation medium such as, e.g. atmospheric oxygen. However, delivery of the oxidation medium can be effected with a separate delivery device.

For controlling the operation of the metering device 18, control means (electronic or mechanical) can be used, such as, e.g., as sensors, which cooperate with a device for controlling the operation of the metering device.

In order to be able to retain the drive piston 13 with a predetermined retaining force in its upper dead point position (the position shown in the figure) adjacent to the combustion chamber 14, there is provided, in the transition region between the combustion chamber 14 and the piston guide 12, magnetic piston-retaining means 31, e.g., permanent magnet means. A spacer 33 is provided between the drive piston 13 and the magnetic piston-retaining means 31. The spacer 33 performs a double function, namely, a shock-absorbing function and a thermal protective function. The spacer 33 can, e.g., be formed of an elastic, thermo-insulating plastic material or ceramics. The spacer 33 prevents wear and/or damage of the magnetic piston-retaining means 31. A magnetic flux-conducting element 32, which is formed as a pole piece, insures an indirect magnetic contact of the magnetic piston-retaining means 31 and the drive piston 13. The magnetic flux-conducting element 32 surrounds, at least regionwise, the magnetic piston-retaining means 31 and transmits its magnetic flux to the piston 13 when the latter is located in the upper dead point position. An indirect transmission of the magnetic flux to the drive piston 13 prevents wear or damage of the magnetic piston-retaining means 31.

The magnetic piston-retaining means (31) can include one or more retaining elements. In this case, a separate magnetic flux-conducting element is associated with each retaining element.

The setting tool 10 is actuated for effecting a setting process with an actuation switch 23 (mechanical and/or electronic) which is provided on a handle 21 of the setting tool 10. The switch 23 is actuated after the setting tool 10 was pressed against a constructional component and a fastening element is fed into the bolt guide 15. Already when the setting tool is being pressed against the constructional component, a predetermined amount of fuel which is specified by the control device (not shown) is fed by the metering device 18 from the fuel tank 16 to the combustion chamber 14. Upon actuation of the setting tool 10 by the actuation switch 23, an ignition device (not shown) is actuated, and it supplies sparks for initiating the combustion of an oxidation means-fuel mixture in the combustion chamber 14.

The drive piston 13 is only then displaced in the chamber 19 of the piston guide 12 by expanding combustion gases when the retaining force of the magnetic piston-retaining means 31 is overcome.

Though the present invention was shown and described with references to the preferred embodiments such are merely illustrative of the present invention and are not to be construed as a limitation thereof and various modifications of the present invention will be apparent to those skilled in the art. It is, therefore, not intended that the present invention be limited to the disclosed embodiment or details thereof, and the present invention includes all variations and/or alternative embodiments within the spirit and scope of the present invention as defined by the appended claims.

What is claimed is:

1. A combustion-engined setting tool for driving fastening elements into a constructional component, comprising at least one combustion chamber (14) for combusting a fuel-oxidation means mixture; a piston guide (12) adjoining the combustion chamber (14); a drive piston displaceable in the piston guide (12) under action of expanding combustion gases; magnetic piston-retaining means (31) for temporarily retaining the drive piston (13) at the combustion chamber (14); and at least one magnetic conducting element (32) for transmitting a magnetic holding force from the magnetic piston-retaining means (31) to the drive piston (13).

2. A setting tool according to claim 1, wherein the magnetic piston-retaining means (31) comprises several retaining elements, with a separate magnetic conducting element being associated with each retaining element.

3. A setting tool according to claim 1, wherein the magnetic piston-retaining means (31) comprises at least one permanent magnet.

4. A setting tool according to claim 1, wherein the magnetic piston-retaining means (31) comprises at least one electromagnet.

5. A setting tool according to claim 1, wherein the magnetic flux-conducting element (32) is formed as pole piece.

6. A setting tool according to claim 1, wherein the magnetic flux-conducting element (32) is formed of a magnetic flux-conducting iron alloy.

7. A setting tool according to claim 1, further comprising a spacer (33) provided between. the magnetic piston-retaining means (32) and the drive piston (13).

8. A setting tool according to claim 7, wherein the spacer (33) is formed as a shock-absorbing element.
